(19) United States
(12) Patent Application Publication
(10) Pub. No.: US 2009/0136319 A1
(43) Pub. Date: May 28, 2009

(54) THREADED SCREW FASTENER

(75) Inventors: Cheryl L. Panasik, Elburn, IL (US); Naim Mansour, Villa Park, IL (US); Yongping Gong, Glenview, IL (US)

Correspondence Address: Levenfeld Pearlstein, LLC (ILLINOIS TOOL WORKS), 2 North LaSalle Street, Suite 1300, Chicago, IL, 60602, US

(73) Assignee: ILLINOIS TOOL WORKS INC., Glenview, IL (US)

(21) Appl. No.: 11/945,448

(22) Filed: Nov. 27, 2007

(51) Int. Cl. F16B 23/00; B23P 19/06

(52) U.S. Cl. 411/404; 29/798

(57) ABSTRACT

A threaded screw fastener has a point, a shank and a head. The point is a ballistic point. The shank comprises a linear travel area, preferably unthreaded, adjacent to the point and a threaded area between the linear travel area and the head. The head is a bugle head formed with a Phillips-style recess configured to receive a driver or driving bit. The fastener is configured fasten a surface material to a substrate material and to be linearly driven into the materials before rotation of the fastener is required, thus reducing the number of rotations required to drive the fastener. The fastener is particularly suited to be used with powered driving tools that utilize both linear and rotating driving means.

### BACKGROUND OF THE INVENTION

The present invention relates generally to threaded screw fasteners, and more particularly to an improved threaded screw fastener configured with a ballistic point adjacent to a linear travel area on the shank to allow the fastener to be driven into a material before the fastener is rotated.

Threaded screw fasteners are well known in the art and are widely used for numerous fastening applications. In one such application, threaded screw fasteners are used to fasten a surface material, such as exterior gypsum sheathing or interior dry wall, to a substrate material, such as steel or wood framing elements (for example, wood or light gauge steel studs).

For use in such applications, the threaded screw fastener typically is formed with a bugle head (oftentimes having a recess configured to receive a Phillips-head driver or driving bit), a threaded shank (with either single lead or double lead threads) and a sharp point or tip. In some embodiments, the point is formed with self-drilling flutes which are particularly useful when the fastener is driven into a heavier gauge metal substrate.

Threaded screw fasteners may be driven using any of a variety of prior art fastener driving tools, such as manual screwdrivers and powered driving tools, such as screw guns. Powered driving tools, which are commonly used in the construction industry, may be powered by various means, such as electrically, pneumatically, by combustion or by combinations of the foregoing.

In high production settings, threaded screw fasteners may be stored in a carrier strip which feeds the fasteners to the powered driving tool in a continuous, rapid fashion. Such carrier strips generally comprise a plurality of evenly spaced apertures through which the screws extend transversely with the fastener heads resting near or against the carrier strip. In this manner, the fasteners may be quickly fed to the powered driving tool which engages each fastener in the carrier strip and, by linear or rotational movement, detaches the fastener from the strip and drives it into the desired material.

Powered driving tools configured to engage prior art threaded screw fasteners stored in a carrier strip, separate an individual fastener from the carrier strip by linear motion (that is, motion in the direction of the longitudinal axis of the fastener) and rotationally drive the fastener into a material are known in the art. However, known prior art devices rotate the faster as it is driven into the material since prior art threaded screw fasteners are formed with threads along essentially the entire length of the shank.

The process of rotationally driving the threaded screw fastener for the entire length of the fastener shank, even with the use of powered driving tools, adds time to the driving process. In a high production setting, even a small amount of time saved when each fastener is driven can add up to a significant time savings over the course of hundreds or thousands of fasteners.

Moreover, when driving such fasteners into a relatively hard substrate material, such as steel or wood framing elements, additional force is required to cause the fastener to penetrate the substrate material and to engage the threads of the fastener with the substrate material.

It would be advantageous, especially when using powered driving tools employing both linear and rotational movement to detach a fastener from a carrier strip and drive it into a material, to have a threaded screw fastener that decreases the number of rotations required to drive the fastener into the material, thereby saving time. Moreover, it would be additionally advantageous if the fastener was configured to form an opening in the material as it was linearly driven into the substrate to ease engagement of the fastener threads.

Accordingly, there is a need for an improved threaded screw fastener configured to be used with powered driving tools employing both linear and rotational movement to drive the fastener into a material. Desirably, the fastener is configured to reduce the number of rotations required to drive the fastener into a material using when using such a tool. More desirably, the fastener is configured to form an opening in the material as it is linearly driven into the material. Most desirably, the fastener is configured such that it need not be rotated as it is linearly driven into the material in order to reduce the time required to subsequently rotatably drive the fastener into material.

### BRIEF SUMMARY OF THE INVENTION

A threaded screw fastener has a point, a shank and a head. The point is a ballistic point and is formed distal most from the head. The point is unthreaded.

The shank comprises a linear travel area adjacent to the ballistic point and a threaded area between the linear travel area and the head. The linear travel area is unthreaded in the preferred embodiment. However, in some embodiments the linear travel area may be threaded, preferably with threads having a thread height less than the thread height of the threads of the threaded area.

The threaded area of the shank comprises a conventional double lead thread formation with a tapered area at the distal end of the shank (adjacent to the linear travel area and furthest from the head). The conventional double lead thread formation defines an inclined front flank surface and an inclined rear flank surface each formed at about an equal angle (about 30 degrees, in the preferred embodiment) relative to a plane through and normal to the shank.

The head is a bugle head. The bugle head is formed with a Phillips-style recess configured to receive a driver or driving bit.

The threaded screw fastener is configured to be used with powered driving tools that use both linear and rotational movement to drive the fastener into a material. More particularly, the fastener of the present invention is particularly useful to fasten a surface material, such exterior gypsum sheathing or interior drywall, to a substrate material, such as steel or wood framing elements. However, it will be appreciated that the present fastener may be advantageously used with other driving tools, both powered and manual, and for myriad other fastening applications.

In one application, the fastener of the present invention, typically stored on a carrier strip with other such fasteners, is fed to a powered driving tool. The powered driving tool includes a driving bit that engages the head of the fastener and linearly drives the fastener in a direction generally normal to the materials to be fastened and towards the materials. The linear motion of the driving bit is not accompanied by rotational motion of the driving bit.

In this manner, the ballistic point of the fastener penetrates the surface material (exterior gypsum sheathing or interior drywall, for example) and further penetrates the substrate material (steel or wood framing, for example) to a distance about equal to the length of the linear travel area. As the ballistic point penetrates the substrate material, it forms an opening configured to engage the threaded portion of the shank.

After the fastener is linearly driven, the fastener is rotatably driven by the powered driving tool, causing the threaded area of the shank to engage the opening formed by the ballistic point and driving the fastener deeper into the substrate material. Once the head of the material is flush, or slightly countersunk, with respect to the surface material, the rotation of the fastener is ceased and the tool is disengaged.

In this manner, the threaded screw fastener of the present invention reduces the number of rotations required to drive the fastener into the materials to be fastened (since a portion of the fastener, that being the ballistic point and the linear travel area, is linearly, and not rotatably, driven into the materials).

Moreover, the configuration of the ballistic point creates an opening in the substrate material during the linear driving process that facilitates engagement of the threaded area of the shank. When the substrate material comprises steel, such as a steel stud, the opening created by the ballistic point includes a collar-like structure that provides additional material with which the threaded portion of the fastener may engage, thereby increasing pull-out resistance.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of the threaded screw fastener with linear travel area embodying the principles of the present invention;

FIG. 2 is an enlarged side view of the fastener;

FIG. 2A is an enlarged side view of an alternate embodiment of the fastener having a threaded linear travel area:

FIG. 3 is an enlarged, partial cross-sectional view of the thread structure on the fastener:

FIG. 4 is an enlarged, top view of the fastener;

FIG. 5 is a fragmentary sectional view of the fastener penetrating a surface material and a substrate material; and,

FIG. 6 is a fragmentary sectional view of the fastener penetrating a surface material and a steel stud substrate material.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention,” relates to a requirement of the United States Patent Office, and does not imply, nor should be inferred to limit the subject matter disclosed herein.

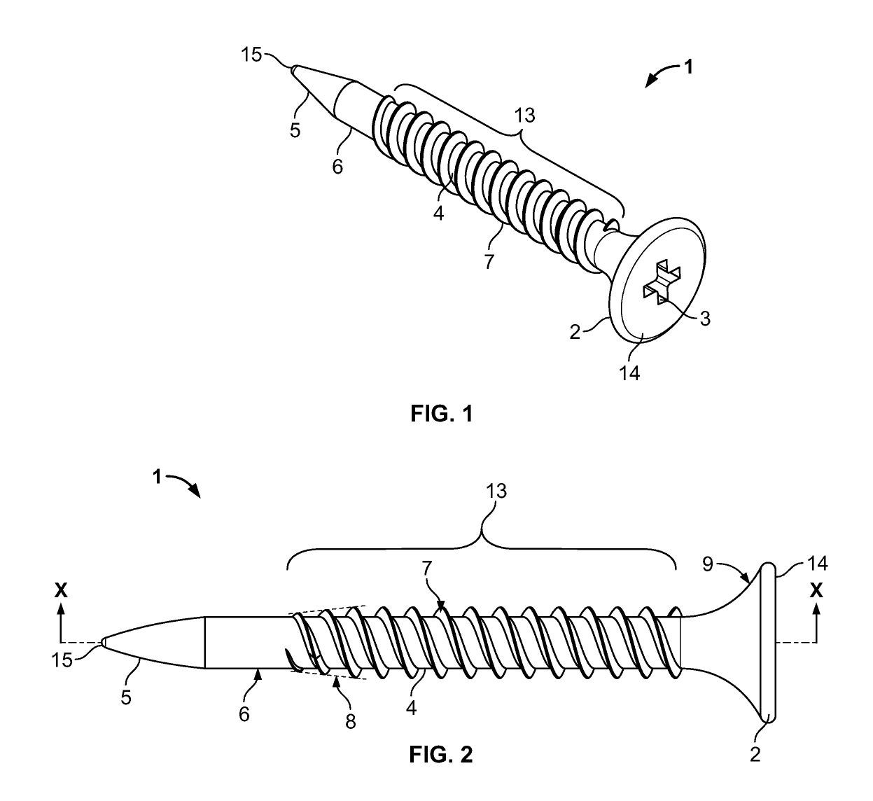

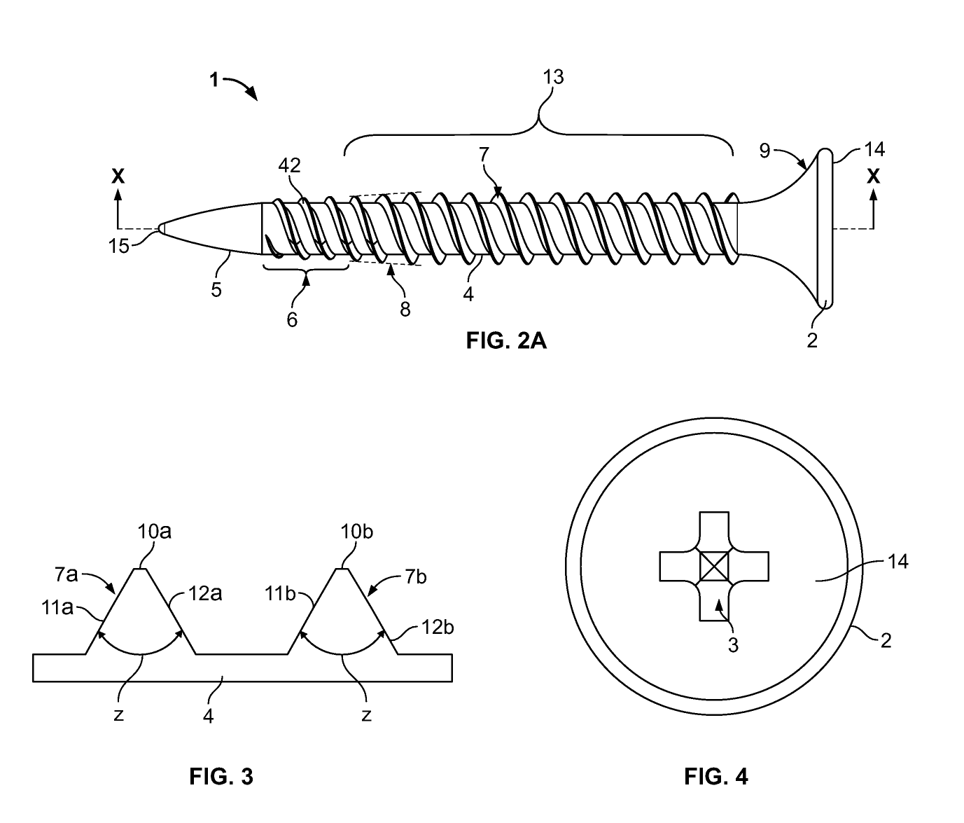

Referring to the figures and in particular to FIGS. 1 and 2, there is shown a threaded screw fastener 1 embodying the principles of the present invention.

Fastener 1 comprises a point 5, a shank 4 and a head 2. Point 5 is formed in a generally ballistic shape, having a rounded tip 15 at the distal end of fastener 1 (distal most from head 2) and a tapered body transitioning to form shank 4. Point 5 preferably is unthreaded.

Shank 4 is generally cylindrical in shape and comprises two areas, an linear travel area 6 and a threaded area 13. Linear travel area 6 preferably is disposed adjacent to point 5 and between point 5 and threaded area 13. Linear travel area 6 preferably is unthreaded and, as discussed below, is configured to be driven into a surface and substrate material in a linear fashion, without rotation of fastener 1.

However, in some embodiments of fastener 1, as shown in FIG. 2A, linear travel area 6 may be threaded. In such an embodiment, threads 42 formed on linear travel area 6 preferably have a thread height that is less than the thread height of threads 7 of threaded area 13. In this manner, fastener 1 still may first be driven linearly, without rotation, into a surface material and substrate material without threads 44 of linear travel area 6 creating a too large an opening in the surface material and substrate material such that threads 7 of threaded area 13 cannot sufficiently frictionally engage the materials.

Threaded area 13 of shank 4 is disposed between linear travel area 6 and head 2. Threaded area 13 preferably comprises a conventional double lead thread formation as is known in the art. In such a thread formation, threads 7 extend around shank 4 in a generally helical configuration such that, when rotatably driven into a material, fastener 1 advances a distance equal to twice the pitch (or distance between corresponding points on adjacent threads 7) for each full rotation of fastener 1. Such a double lead thread formation is well known in the art.

It will be appreciated, however, that while the double lead thread formation used in the preferred embodiment of the present invention advantageously results in the a more rapid advancement of fastener 1 into a material when rotatably driven, threaded area 13 of fastener 1 may utilize a variety of different thread formations as are known in the art without departing from the scope of the present invention.

Threaded area 13 further includes a tapered area 8 at the distal end of threaded area 13 (distal most from head 2). In the preferred embodiment, tapered area 8 comprises about the first three threads of threaded area 13 and is configured such that the height of the threads in tapered area 8 increases gradually from the first thread (the thread adjacent to linear travel area 6) to the third thread (the thread.

As shown in FIG. 3, each thread 7 (adjacent threads are shown as 7a and 7b in FIG. 3) in threaded area 13 defines an inclined front flank surface 11a, 11b and an inclined rear flank surface 12a, 12b. Front flank, surface 11a, 11b and rear flank surface 12a, 12b are joined by a generally flat top surface 10a, 10b. In the preferred embodiment, front flank surface 11a, 11b and rear flank surface 12a, 12b each are formed at about an equal angle (most preferably at about 30 degrees) relative to a plane through and normal to the shank. Such as configuration results in a thread angle z of about 60 degrees.

As shown in FIGS. 1, 2 and 4, head 2 of fastener 1 is disposed at the proximate end of fastener 1, adjacent to threaded area 13 of shank 4. Head 2 preferably is formed as a bugle head as known to those skilled in the art. Head 2 is configured with a flat top 14 and a concave underhead bearing surface 9.

As those skilled in the art will recognize, the configuration of head 2 is particularly useful when fastening exterior gypsum sheathing or interior dry wall to a substrate material since the bugle head design is configured to countersink slightly into the surface material (created a flat or nearly flat surface) and to distribute bearing stress over a wider area than flat head fasteners.

Flat top 14 of head 2 comprises a recess 3 configured to receive a driver or driving bit for linearly and rotatably driving fastener 1 into a material. In the preferred embodiment recess 3 is configured as a Phillips-style recess as is known in the art. However, other shapes and styles for recess 3 may be used without departing from the scope of the present invention.

A sample threaded screw fastener was formed in accordance with the principles of the present invention. The fastener had a length of about 1.28 inches from tip to head and a shank diameter of about 0.10 inches. The length of the point was about 0.20 inches, the length of the linear travel area was about 0.10 inches, the length of the threaded area was about 0.78 inches and the length of the head was about 0.20 inches.

The point was formed in a ballistic geometry and was unthreaded. The linear travel area was unthreaded. The threaded area was configured with a double lead thread formation. The threads had a thread height of about 0.025 inches, a thread pitch of about 0.058 inches and a thread angle of about 60 degrees. The flat top of threads had a length of about 0.003 inches). Finally, the head was formed with a bugle geometry having a diameter of about 0.33 inches with a Phillips-style recess.

When used with a powered driving tool that employed both linear and rotating driving functions, it was found that it took less time to drive the sample fastener than a prior art fastener, since it required fewer rotations to drive the fastener (the fastener did not need to be rotated while the point and the linear travel are were driven linearly into the material) and since the ballistic point of the fastener acted to form an opening in the material that facilitated engagement of the threaded area of the fastener.

In use, the threaded screw fastener of the present invention is quite suitable for fastening a surface material, such as exterior gypsum sheathing or interior drywall, to a substrate material, such as steel or wood framing elements, particularly when the fastener is used in connection with a powered driving tool that employs both linear and rotational movement to drive the fastener.

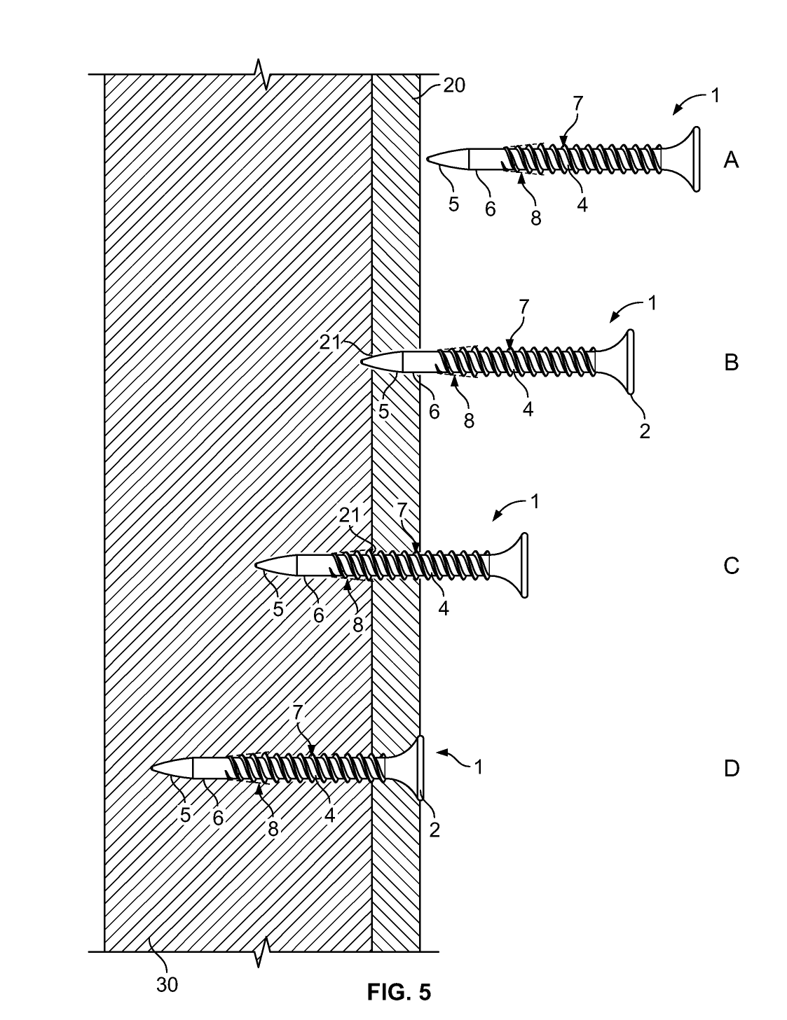

As shown in FIG. 5, a surface material 20 (such as exterior gypsum sheathing or interior drywall) is to be fastened to a substrate material 30 (such as a steel or wood framing element) using threaded screw fastener 1 of the present invention and a driving tool (not shown).

As depicted in “A,” fastener 1 is positioned to adjacent to surface material 20 in preparation for being driven into surface material 20 in order to fasten surface material 20 to substrate material 30. As shown in “B,” fastener 1 has been driven linearly, without rotation, such that point 5 has penetrated surface material 20 and substrate material 30, point 5 having formed an opening 21 in substrate material 30, and linear travel area being disposed essentially within surface material 20.

At “C,” rotation of fastener 1 has begun and point 5 of fastener 1 has fully penetrated substrate material 30, and threads 7 have rotatably engaged opening 21 drawing fastener deeper into substrate material 30. Finally, at “D” fastener 1 is full driven into surface material 20 and substrate material 30, thereby fastening surface material 20 to substrate material 30. Head 2 is countersunk slightly into surface material 20 and threads 7 are securely engaged with substrate material 30.

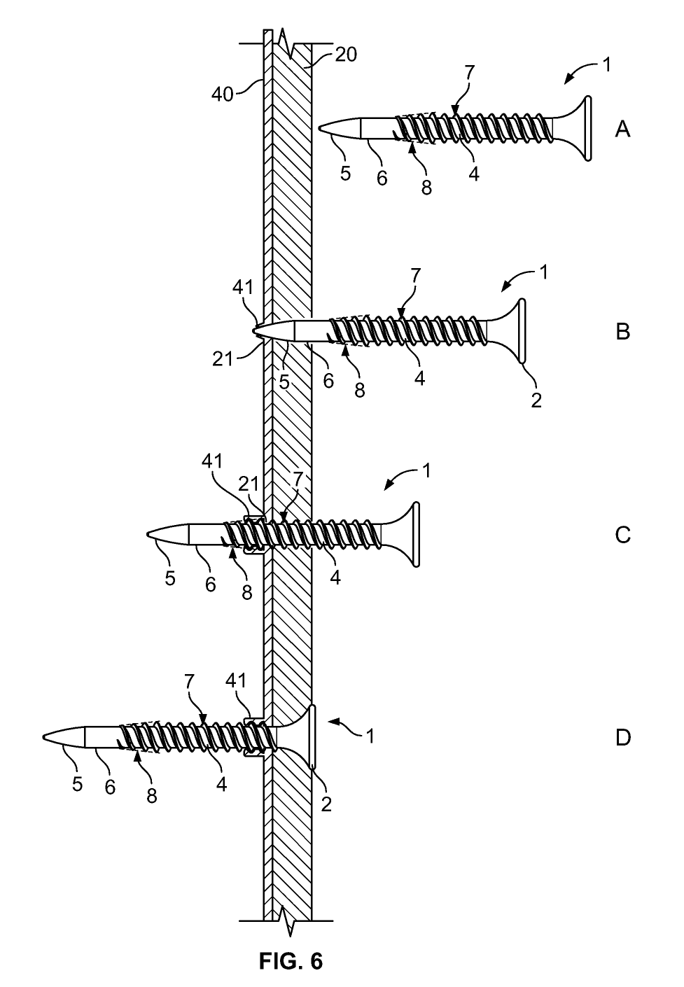

As further shown in FIG. 6, a surface material 20 (such as exterior gypsum sheathing or interior drywall) is to be fastened to a substrate material, in this case a steel stud 40 (only a portion of steel stud 40 is shown in FIG. 6) using threaded screw fastener 1 of the present invention and a driving tool (not shown).

As depicted in “A,” fastener 1 is positioned to adjacent to surface material 20 in preparation for being driven into surface material 20 in order to fasten surface material 20 to steel stud 40. As shown in “B,” fastener 1 has been driven linearly, without rotation, such that point 5 has penetrated surface material 20 and steel stud 40, point 5 having formed an opening 21 in substrate material 30, and linear travel area being disposed essentially within surface material 20. Additionally, in forming opening 21, the ballistic shape of point 5 has caused a portion of steel stud 40 to begin to form a collar-like structure 41 around opening 21.

At “C,” point 5 of fastener 1 has fully formed and passed through opening 21 while at the same lime having fully formed collar-like structure 41. At “C,” rotation of fastener 1 has begun and threads 7 have rotatably engaged opening 21 drawing fastener deeper into steel stud 40. Threads 7 also have engaged collar-like structure 41, providing additional frictional engagement with steel stud 40 and, therefore, additional pull-out resistance.

Finally, at “D,” fastener 1 is fully driven into surface material 20 and steel stud 40, thereby fastening surface material 20 to steel stud 40. Head 2 is countersunk slightly into surface material 20 and threads 7 are securely engaged with steel stud 40, including collar-like structure 41.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A threaded screw fastener comprising:
a point;
a shank; and
a head;
wherein the shank comprises a linear travel area disposed adjacent to the point, and a threaded area disposed between the linear travel area and the head.

2. The threaded screw fastener of claim 1 wherein the point has a generally ballistic shape.

3. The threaded screw fastener of claim 1 wherein the shank is generally cylindrical.

4. The threaded screw fastener of claim 1 wherein the linear travel area is unthreaded.

5. The threaded screw fastener of claim 1 wherein the linear travel area is threaded.

6. The threaded screw fastener of claim 1 wherein the threaded area comprises a conventional thread formation.

7. The threaded screw fastener of claim 6 wherein the conventional thread formation is a double lead thread formation.

8. The threaded screw fastener of claim 1 wherein the threaded area comprises a tapered area disposed adjacent to the linear travel area.

9. The threaded screw fastener of claim 1 wherein the head is a bugle head.

10. The threaded screw fastener of claim 1 wherein the head comprises a recess.

11. The threaded screw fastener of claim 10 wherein the recess is a Phillips-style recess.

12. The threaded screw fastener of claim 6 wherein the conventional thread formation comprises a plurality of threads, each of the plurality of threads having a front flank surface, a rear flank surface and top surface.

13. The threaded screw fastener of claim 12 wherein each of the plurality of threads has a thread angle of about 60 degrees.

14. The threaded screw fastener of claim 1 wherein the point further comprises a tip.

15. The threaded screw fastener of claim 14 wherein the tip is rounded.

16. The threaded screw fastener of claim 6 wherein the conventional thread formation defines an inclined front flank surface and an inclined rear flank surface each formed at about an equal angle relative to a plane through and normal to the shank.

17. A method for securing a surface material to a substrate material, the method comprising the steps of:
providing a threaded screw fastener, the fastener having a point, a shank and a head, wherein the shank comprises a linear travel area disposed adjacent to the point and a threaded area disposed between the linear travel area and the head;
non-rotatably driving the threaded screw fastener into the surface material and the substrate material such that the point penetrates the substrate material to form an opening; and
rotatably driving the threaded screw fastener into surface material and the substrate material such that the threaded area engages the opening formed in the substrate material.

18. The method for securing a surface material to a substrate material of claim 17, the method further comprising the step of:
additionally rotatably driving the threaded screw fastener into the surface material and the substrate material until the head of the threaded screw fastener is about flush with the surface material.

19. The method for securing a surface material to a substrate material of claim 17 wherein the substrate material is comprised of steel.

20. The method for securing a surface material to a substrate material of claim 19 wherein the opening further comprises a collar-like structure formed about the opening, and wherein the threaded area engages the collar-like structure.
